(19) United States
(12) Patent Application Publication
(10) Pub. No.: US 2022/0215985 A1
(43) Pub. Date: Jul. 7, 2022

(54) COMBINATION CABLE FOR ELECTRICAL ENERGY AND DATA TRANSMISSION

(71) Applicant: LEONI KABEL GMBH, Roth (DE)

(72) Inventors: Erwin KOEPPENDOERFER, Schwabach (DE); Michael HAEUSLSCHMID, Emskirchen (DE); Frank HARRMANN, Nuernberg (DE)

(21) Appl. No.: 17/606,375

(22) PCT Filed: Apr. 23, 2020
(86) PCT No.: PCT/EP2020/061270

§ 371 Date: Oct. 25, 2021

(30) Foreign Application Priority Data
Apr. 26, 2019 (DE) 10 2019 110 878.0

(51) Int. Cl. H01B 9/00; H01B 11/10

(52) U.S. Cl. CPC H01B 9/003; H01B 11/04; H01B 11/10

(57) ABSTRACT

A combination cable for electrical energy and data transmission has one or more high-current lines and a first data line pair, which has two intertwined data lines that are at least partly surrounded by an at least partly electrically conductive sheath. The combination cable furthermore has a second data line pair that has two data lines that are spaced from one another. The data lines that are spaced from one another of the second data line pair are each arranged on an outer surface of the at least partly electrically conductive sheath of the first data line pair.

A combination cable for electrical energy and data transmission is described here.

Combination cables for energy and data transmission are used to transmit electrical energy on the one hand, and on the other hand to enable a data transmission via separate data lines provided for this.

Combination cables of this kind are used, for example, in the technical fields of automotive construction, aerospace technology, mechatronics and industrial robot technology. The use of combination cables is advantageous, for example, when a technical operating unit is to be supplied with sufficient operating energy and electronic control signals are to be transmitted to the operating unit at the same time, for example.

Combination lines are known with a high-current line pair and at least two data line pairs. Such combination lines are disclosed, for example, by the documents WO 2016/151 752 A1, WO 2016/151 754 A1, KR 2015 0 140 512 A, FR 1 255 998 A, US 2006/021 786 A1 and WO 2018/198 475 A1.

A disadvantage of these known combination lines is that on account of inductive and capacitive coupling effects between the individual lines, in particular between the high-current lines and the data line pairs, but also between the data line pairs themselves, the quality of data transmission is negatively affected as compared with using separate data lines.

This disadvantage is normally counteracted by stranding of the individual lines, both of the high-current lines and the data lines, and by the use of electromagnetic shielding, in particular by the use of foil shields or braided shields for the individual lines. Although impairment of the quality of the data transmission can be reduced in this way, both measures have disadvantages for the assembly of the cables. The stranding of several individual lines thus makes assembly more difficult, for example, when the individual lines are to be arranged in respectively prepared contact locators at a connection point. Furthermore, the individual shields must be stripped and separately earthed for the most part to connect the lines of a combination cable electrically to the connection point, which is laborious and therefore increases the required assembly time.

Despite existing combination cables with high-current lines and several data line pairs, further improvements are therefore required to avoid the disadvantages described.

In particular, a combination cable for electrical energy and data transmission is to be provided that structurally counteracts impairment of the quality of a data transmission due to capacitive and inductive interactions of the individual lines and in particular improves assemblability compared with known combination cables.

This object is achieved by a device according to claim 1. Specific configurations are defined by the dependent claims.

A combination cable for electrical energy and data transmission has one or more high-current lines. In particular, the combination cable can have two high-current lines, but cable arrays with three, four or more high-current lines are also explicitly possible.

High-current lines in the sense of this disclosure are electrical conductors, conductor bundles, conductor braids or conductor wires that are suitable for supplying an electrical consumer with electrical energy and in doing so transporting electrical energy or power and providing this electrical energy to the electrical consumer at a conductor end. The high-current line defined here can be used, depending on dimensioning, not only in the high-voltage range but also in the medium-voltage range and also in the low-voltage range. For example, this can be adapted to support an alternating current with a voltage of 230 volts, a frequency of 50 hertz and a maximum current strength of 20 amperes. Any other configurations or dimensionings are also explicitly possible, however, wherein the energies maximally transmissible by means of the high-current lines always exceed the energies transmissible by means of a data line. The high-current lines can be adapted both for the transmission of alternating current and for the transmission of direct current.

The combination cable further has a first data line pair, which has two data lines stranded with one another, which are enclosed at least partly by an at least partly electrically conductive sheath. In particular, the sheath can enclose the first data line pair completely up to the contact points of the data lines at the connection points of the combination cable and thus also create a spacing from other elements of the combination cable. The at least partly electrically conductive sheath can in this case have an insulation layer, which forms an outer jacket surface of the electrically conductive sheath. The outer jacket surface here describes the surface of the sheath facing away from the first data line pair, in particular in a radial (cable) direction. Furthermore, the combination cable has a second data line pair, which has two data lines spaced at a distance from one another. The data lines of the second data line pair that are spaced at a distance from one another are each arranged on an outer jacket surface of the at least partly electrically conductive sheath of the first data line pair. In this case the data lines of the second data line pair in the sense of this disclosure are to be regarded in particular also as being arranged on the outer jacket surface of the at least partly electrically conductive sheath of the first data line pair when another material layer, in particular a (stripped) insulation layer or an insulating varnish layer is located between the actual data lines of the second data line pair and the outer jacket surface of the sheath. In other words, it can be described that the data line including an insulating layer enclosing the data line can be arranged on the outer jacket surface of the sheath of the first data line pair.

The data lines of the second data line pair that are spaced at a distance from one another can be spaced from one another, for example, at a distance of 1% to 31%, in particular of 10% to 25%, of a jacket circumference of the sheath. In one variant, the data lines can be arranged on the outer jacket surface of the sheath in such a way that they are spaced from one another by the distance of 75% to 100%, in particular 80%, of a cross-sectional diameter of the sheath.

One advantage of the combination cable is that stranding of the conductors with one another and the use of electromagnetic shields for the conductors can be at least partly eliminated. The at least partly electrically conductive sheath of the first data line pair can take up at least a portion of the energy emitted by the conductors by means of electromagnetic waves and convert this at least partly into heat. Impairment of the quality of the data transmission due to the electromagnetic fields caused in particular by the high-current lines on account of capacitive and/or inductive effects can be reduced hereby. The damping effect of the at least partly electrically conductive sheath of the first data line pair on the electromagnetic fields at least also partly covers the second data line pair arranged on the sheath, for which in addition stranding can be completely eliminated. Furthermore, the sheath also causes spacing of the first data line pair from the two data lines of the second data line pair and spacing between the individual data lines of the second data line pair, so that inductive or capacitive coupling between these lines is also counteracted.

The one or more high-current lines can optionally be electrically insulated, for example using an insulating varnish or a dielectric at least partly enclosing the high-current line or lines. Furthermore, at least the one or more high-current line(s) can be at least partly enclosed by an electromagnetic shield, in particular by a foil shield or braided shield.

The data lines of the first and/or of the second data line pair can naturally also be provided with insulation, in particular with an insulating varnish or with a dielectric enclosing the data lines. This is not necessary in all embodiments, however. For example, a copper conductor can be used with/alongside a tin-plated conductor to produce the respective data line pairs. The data line pairs thus produced can run in separated in the installation space in the process of core formation without insulation of the individual copper conductors and tin-plated conductors being required.

Insulation of the data lines can be formed in particular separately from the at least partly electrically conductive sheath of the first data line pair and/or additionally or supplementary to the partly electrically conductive sheath of the first data line pair.

In one variant, the first data line pair can be adapted to transmit data signals at a higher frequency than the second data line pair and/or the second data line pair can be adapted to transmit data signals at a lower frequency than the first data line pair.

Since data signals at a comparatively higher frequency react more sensitively to electromagnetic interference factors and can be more easily impaired by such interference factors than data signals at a comparatively lower frequency, to ensure a still tolerable electromagnetic impairment of the respective data line pairs it is sufficient to arrange the second data line pair on the outer jacket surface of the sheath of the first data line pair, while the first data line pair is enclosed by the at least partly electrically conductive sheath.

In one embodiment, the first data line pair can be adapted to transmit data signals with a frequency of over one kilohertz. The second data line pair can be adapted to transmit data signals with a frequency of below one kilohertz.

In one variant, the first data line pair can be adapted to transmit data signals with a frequency of over one megahertz. The second data line pair can be adapted to transmit data signals with a frequency of below one megahertz. For example, the first data line pair can be adapted to transmit data signals with a frequency of around 5 megahertz to around 100 megahertz, in particular with a frequency of around 50 megahertz, while the second data line pair can be adapted to transmit frequencies in the kilohertz range.

The at least partly electrically conductive sheath that at least partly encloses the first data line pair can have an elliptical, in particular a circular, cross-sectional geometry. In particular, a cross section orthogonal to the length extension of the combination cable can have an elliptical or circular cross-sectional aspect of the sheath. Furthermore, the at least partly electrically conductive sheath can enclose the first data line pair completely in a radial direction of the elliptical or circular cross-sectional geometry. This is not necessary in all embodiments of the combination cable, however.

The at least partly electrically conductive sheath enclosing the first data line pair can optionally have a dielectric coating or lacquering, which forms the outer jacket surface or circumferential surface of the sheath. In other words, it can be described that in particular an outer surface of the at least partly electrically conductive sheath is formed by a material or a material layer with dielectric properties, so that an electrical conductor arranged on the surface does not produce any electrically conductive connection to the at least partly electrically conductive sheath.

In one embodiment, a material is proposed for the at least partly electrically conductive sheath, which at least partly encloses the first data line pair, that has a specific volume resistance of less than 1×10¹⁰ ohm*m, for example thermoplastic elastomers (TPE) such as urethane-based thermoplastic elastomers, also described as thermoplastic polyurethane (TPE-U/TPU). The resistance, which is lower by the factor 10,000 compared with customarily used (sheath) materials such as polyvinyl chloride (PVC), polypropylene (PP), polyethylene (PE), thermoplastic styrene block copolymers (TPE-S/TPS) (with a respective volume resistance of >1×10¹⁴ ohm*m according to DIN EN ISO 62631-3-1) causes conversion of the undesirable electromagnetic radiation into thermal energy. According to the standard, however, TPE-U should be avoided as sheath material in cable manufacture on account of higher leakage currents, which can result from high voltages, and also on account of undesirable electrochemical processes. The use of TPE-U as a production material for the at least partly electrically conductive sheath thus contradicts normal expert implementation variants for cables for electrical energy and data transmission, wherein the special technical advantage described can be achieved by the use of this production material.

The sheath that at least partly encloses the first data line pair can optionally additionally be acted upon by soot particles to support a shielding effect of the sheath. These can contribute a maximum of between 0.3% and 3.0% to the overall volume of the manufactured sheath. The soot particles can have a diameter of approx. 30 nm to 1 μm, for example 50 nm, 250 nm or 500 nm.

By suitable stranding of the first data line pair, for example by stranding with a continuous change of angular orientation of the first data line pair, negative impairment of the transmission quality of the second data line pair due to electromagnetic radiation of the first data line pair can be reduced further via the damping of the electromagnetic radiation caused by the at least partly electrically conductive sheath.

In a further development, the two data lines stranded into the first data line pair can wind continuously around a wick axis of the data line pair, the stranding along the wick axis being arranged offset by half a stranding length or by 180° to the stranding of two high-current lines stranded with a stranding length corresponding to the first data line pair. An advantageous reduction in transmission interference due to electromagnetic radiation of the stranded high-current lines is achieved hereby, as the currents induced by the two high-current lines in the first data line pair at least substantially compensate for one another.

The at least partly electrically conductive sheath can optionally have a variable material thickness or material strength.

In one variant, the combination cable can have at least two high-current lines, which together border a high-current line intermediate space, which is arranged between the two high-current lines. The intermediate space lying between the high-current lines can be filled in this case at least partly or also completely with materials, for example with a portion of the dielectric insulation materials optionally enclosing the high-current lines.

The data lines of the first and the second data line pair can each be spaced by at least a predetermined distance from the high-current line intermediate space.

The data lines of the first and the second data line pair can optionally each be spaced by a straight line, which is tangent to the two high-current lines, in a direction leading away from the high-current lines.

The electromagnetic fields caused by the high-current lines have the comparatively highest electromagnetic field strengths between the straight lines tangent to the two high-current lines, in particular in the area of the bordered intermediate space. It is therefore advantageous to position the data lines of the data line pairs outside of these areas, but this is not absolutely necessary in all embodiments.

If the combination cable has at least two high-current lines, these can be arranged in particular unstranded adjacent to one another. The at least two high-current lines can each be configured similarly or differently from one another. In one example, the at least two high-current lines have an at least substantially identical cross-sectional diameter.

The data lines of the first data line pair and/or the data lines of the second data line pair can each be configured similarly or differently from one another. Furthermore, all data lines of the combination cable can each be configured similarly or differently from one another. In one example, all data lines of the combination cable have an at least substantially identical cross-sectional diameter.

If X is the shortest possible distance of a first straight line, which is tangent to both data lines of the second data line pair, from a second straight line, which runs parallel to the first straight line through a cross-sectional centre point or through a stranding axis of the first data line pair, and if Y is a diameter of a data line of the first data line pair, in particular the diameter of a data line of the first data line pair including insulation of this data line, then X can correspond to at least 0.9 times the value of Y. In other variants of the combination cable, X can correspond at least to 1.0 times or at least 1.1 times the value of Y.

It can be ensured hereby that a minimal distance is created between the lines of the first data line pair that are stranded together and the lines of the second data line pair that are spaced from one another, so that the lines of the first data line pair are not located or are only slightly located in a data line intermediate space enclosed between the lines of the second data line pair that are spaced from one another. Since the electromagnetic fields caused by the lines of the second data line pair have the highest electromagnetic field strengths in the data line intermediate space bordered by them, it is advantageous to arrange the lines of the first line pair that are stranded with one another at least substantially outside of this data line intermediate space.

It is evident to the expert that the aspects and features described previously can be combined in any way.

Other features, properties, advantages and possible modifications will be clear to an expert based on the description below, in which reference is made to the enclosed drawings. Here the figures show schematically and by way of example respective combination cables for electrical energy and data transmission. The dimensions and proportions of the components shown in the figures are not to scale.

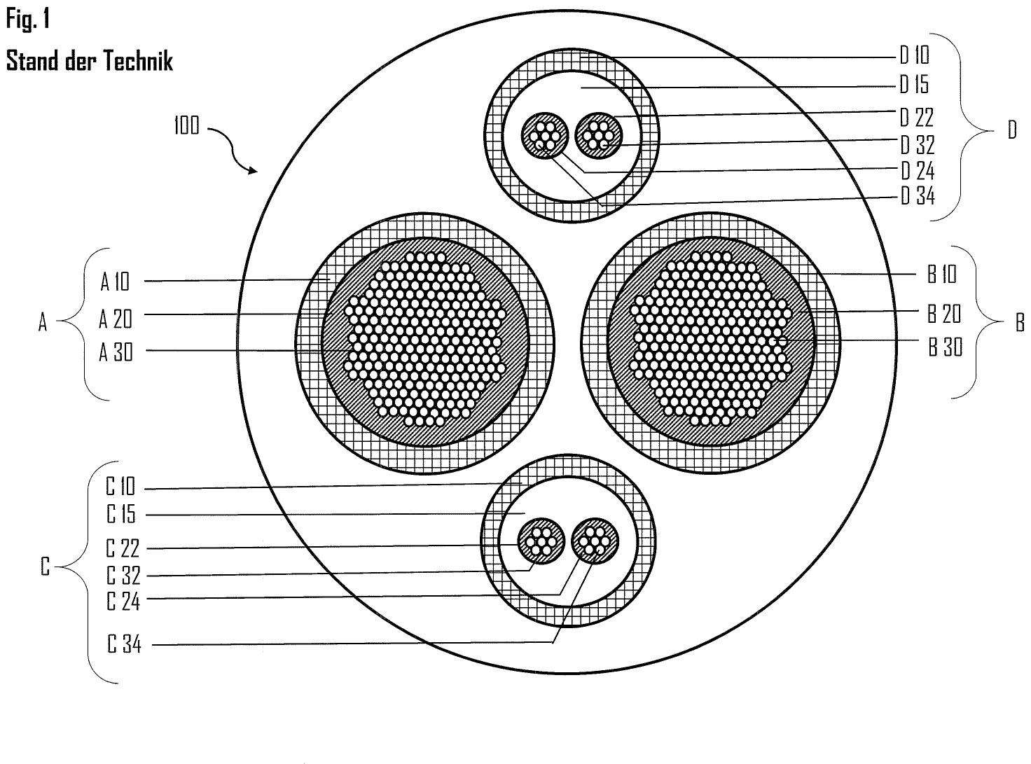

FIG. 1 shows schematically an example of known combination cables for electrical energy and data transmission.

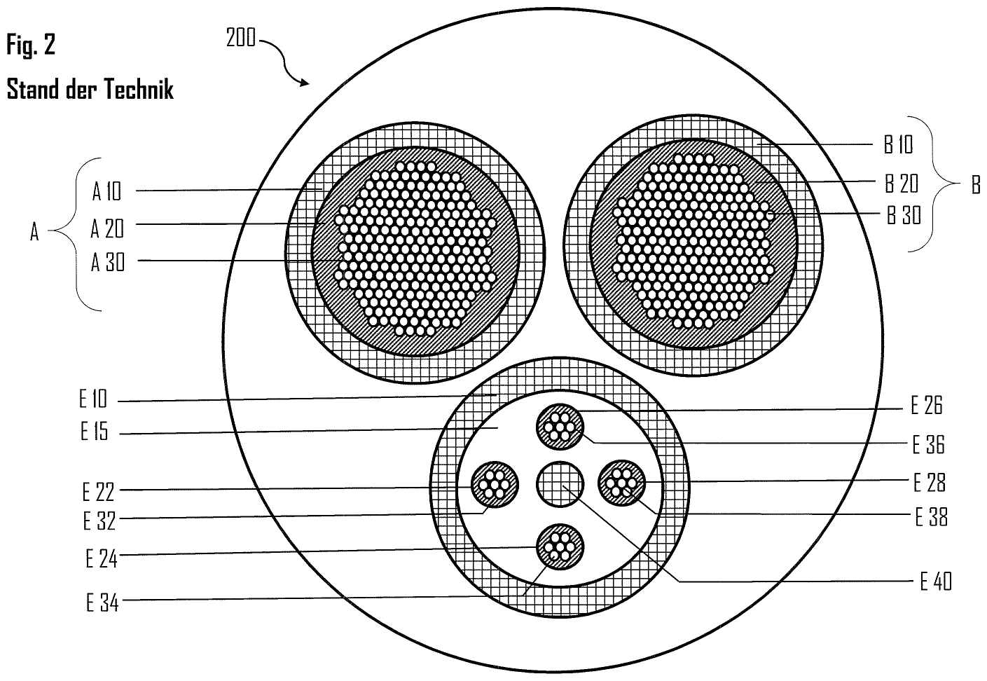

FIG. 2 shows schematically another example of known combination cables for electrical energy and data transmission.

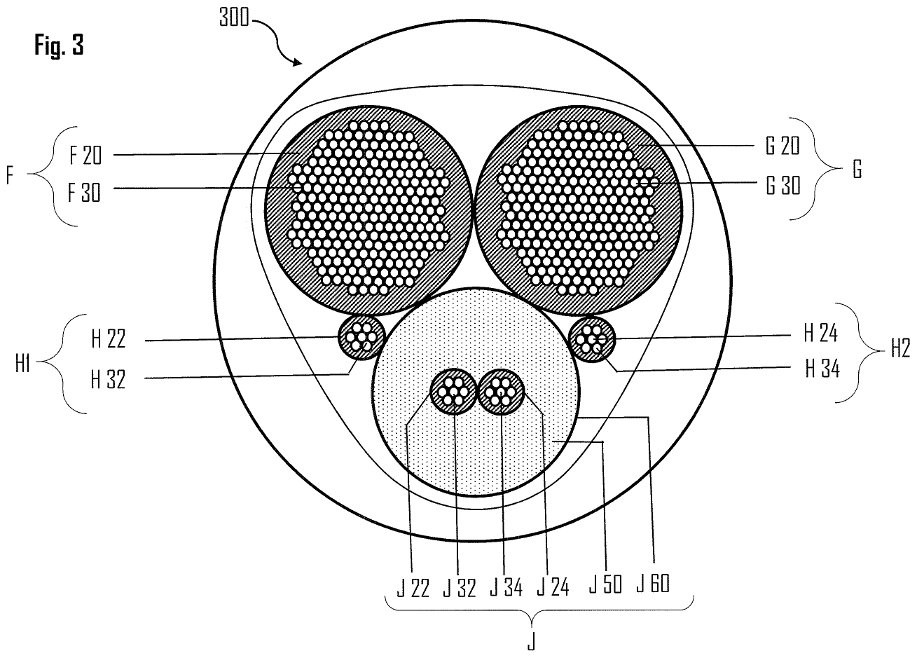

FIGS. 3-5 each show schematically and by way of example a combination cable for electrical energy and data transmission with a partly electrically conductive sheath, which encloses a data line pair.

FIG. 1 shows schematically an example of known combination cables 100 for electrical energy and data transmission in a cross-sectional view. The combination cable 100 has a circular cross-sectional geometry and has a first high-current line arrangement A and a second high-current line arrangement B. The first high-current line arrangement A has a first high-current line A30, a first high-current line insulation A20 and a first high-current line shield A10. The second high-current line arrangement B has a second high-current line B30, a second high-current line insulation B20 and a second high-current line shield B10.

Furthermore, the example of a combination cable 100 shown in FIG. 1 has a first data line arrangement C and a second data line arrangement D. The first data line arrangement C here has a first data line shield C10, a first filler material C15 and a first data line pair, which has two data lines C32, C34 stranded with one another, which are each enclosed by data line insulation C22, C24. The second data line arrangement D here has a second data line shield D10, a second filler material D15 and a second data line pair, which has two data lines D32, D34 stranded with one another, which are each enclosed by data line insulation D22, D24.

Furthermore, the line arrangements A, B, C and D shown in FIG. 1 are stranded with one another to counteract the effects of capacitive and inductive couplings between the line arrangements.

A disadvantage of the device shown in FIG. 1 is that on account of the stranding of the line arrangements and of the shields A10, B10, C10 and D10, assembly of the combination cable 100 is rendered difficult and in particular time-consuming.

FIG. 2 shows schematically another example of known combination cables 200 for electrical energy and data transmission in a cross-sectional view. The high-current line arrangements A and B shown correspond here to the high-current line arrangements shown in FIG. 1 and described above. Deviating from the example shown in FIG. 1, however, the combination cable 200 has a data line arrangement E with the star-quad-twisted or quad-twisted data lines E32, E34, E36 and E38. The data line arrangement E in this case has a data line shield E10, filler material E15, the four star-quad-twisted data lines E32, E34, E36 and E38, which are each enclosed by insulation E22, E24, E26, E28, and the central element E40, around which the star-quad-twisted or quad-twisted data lines E32, E34, E36 and E38 are arranged.

The line arrangements A, B and E shown in FIG. 2 are further stranded with one another to counteract the effects of capacitive and inductive couplings between the line arrangements.

The combination cable shown in FIG. 2 also has the disadvantage that on account of the necessary shields A10, B10 and E10 and on account of the stranding of the line arrangements A, B and E, assembly of the combination cable 100 is rendered difficult and in particular time-consuming.

FIG. 3 shows a cross-sectional view of a combination cable 300, which is easier to assemble in comparison with those in FIG. 1 and FIG. 2 and in comparison with the combination cables described above.

The combination cable 300 has a first high-current line arrangement F and a second high-current line arrangement G. The first high-current line arrangement F has a first high-current line F30, which is enclosed by a first high-current line insulation F20. The second high-current line arrangement G has a second high-current line G30, which is enclosed by a second high-current line insulation G20.

The combination cable 300 further has a first data line arrangement J. The first data line arrangement 3 here has a first pair of data lines 332, 334, which are each enclosed by insulation 322, 324. The data lines 332 and 334 are stranded with one another. The first data line arrangement 3 also has an at least partly electrically conductive sheath 350, which radially encloses the insulated data lines 332, 334 stranded with one another.

The sheath 350 is adapted to take up at least a portion of the electromagnetic waves emitted by the line arrangements and to convert these at least partly into heat. Impairment of the quality of the data transmission due to the electromagnetic fields caused in particular by the high-current lines F30, G30 on account of capacitive and/or inductive effects can be reduced hereby.

The data line arrangement 3 shown as an example in FIG. 3 with the sheath 350 has a dielectric sheath surface 360, which is formed together with the sheath 350. In other words, it can be described that the dielectric sheath surface 360 forms the outer jacket surface or circumferential surface of the at least partly electrically conductive sheath 350.

FIG. 3 further shows that the combination cable 300 has a second data line arrangement H1, H2, which has a pair of data lines H32 and H34 spaced at a distance from one another. In the example shown, the data lines H32 and H34 spaced at a distance from one another are each enclosed by insulation H22, H24, but this is not necessary in all embodiments.

The insulated data lines H32 and H34 of the second data line arrangement H1, H2, which are spaced at a distance from one another, are each arranged on the outer jacket surface 360 of the at least partly electrically conductive sheath 350 of the first data line arrangement J.

In the example shown, the data lines 332, 334 of the first data line arrangement 3 are adapted to transmit data signals with a higher frequency than the data lines H32, H34 of the second data line arrangement H1, H2. For example, the data lines 332, 334 can be adapted for the transmission of data signals with a frequency of one megahertz or higher, while the data lines H32, H34 are adapted for the transmission of data signals with a frequency of less than one megahertz.

Since data signals with a comparatively higher frequency react more sensitively to electromagnetic interference factors and can be impaired more easily by such interference factors than data signals with a comparatively low frequency, to ensure still tolerable electromagnetic impairment of the respective data line pairs it is sufficient for the data lines H32, H34 of the second data line arrangement H1, H2 to be arranged on the outer jacket surface 360 of the sheath of the first data line arrangement 3, while the data lines 332, 334 of the first data line arrangement 3 are enclosed by the at least partly electrically conductive sheath 350.

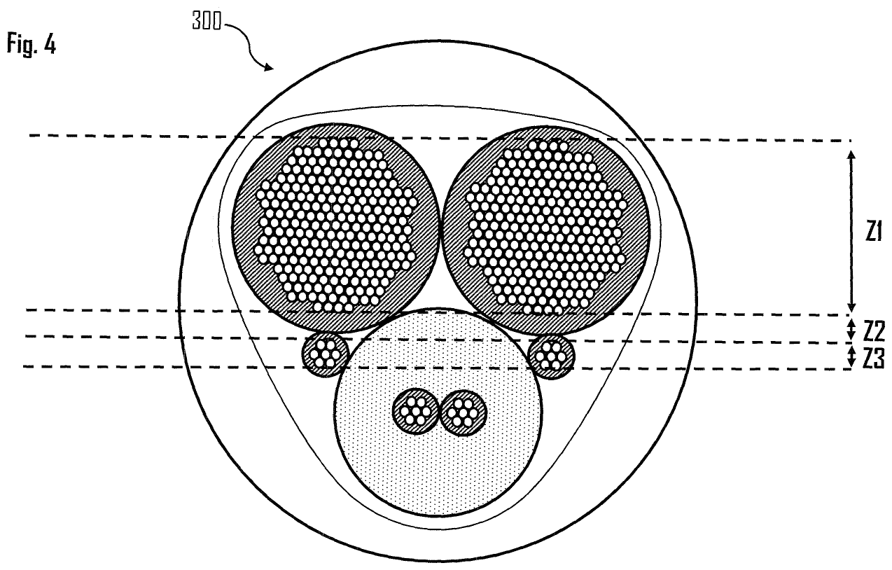

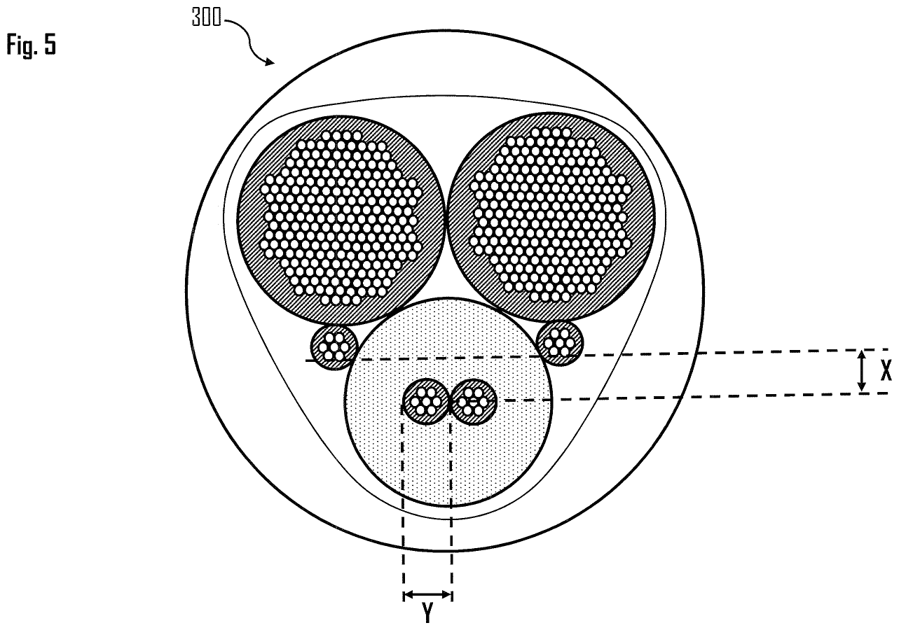

FIGS. 4 and 5 serve to further clarify advantageous aspects of the combination cable 300 shown in FIG. 3. The device constituents of the combination cable 300 shown in FIGS. 4 and 5 are not provided with reference characters for reasons of clarity, the construction of the combination cable 300 shown in FIGS. 4 and 5 being identical in each case to that of the combination cable 300 described previously and shown in FIG. 3.

FIG. 4 illustrates that all data lines H32, H34, 332, 334 of the combination line 300 are spaced by at least the distance Z2 from one of the high-current lines F30, G30. Furthermore, all data lines H32, H34, 332, 334 of the combination line 300 are also spaced from an intermediate space bordered by the high-current lines F30, G30 and/or from an area between two straight lines parallel to one another, which are each tangent to the two high-current lines F30, G30. In other words, it can be described that the data lines H32, H34, 332, 334 are arranged, in a cross-sectional view of the combination line 300, each in a different vertical plane/cross-sectional plane than the high-current lines F30, G30.

One advantage here is that the electromagnetic fields produced by the high-current lines F30, G30 in an area between two straight lines parallel to one another that are each tangent to the high-current lines F30, G30 have the greatest electromagnetic field strengths, so that spacing the data lines at a distance from this area counteracts an impairment of the quality of data transmission.

FIG. 5 illustrates that the data lines 332, 334 stranded with one another are also spaced at a distance from the data lines H32, H34 arranged on the outer surface 360 of the at least partly electrically conductive sheath 350 in such a way that the data line pairs of the data line arrangements H and 3 are each arranged, in a cross-sectional view of the combination line 300, in a different vertical plane/cross-sectional plane. In other words, it can be described that the stranded data lines 332, 334 are not located or are at least scarcely located in an intermediate space bordered by the data lines H32, H34 arranged on the outer surface 360 of the sheath 350.

This is ensured in the example shown in that if X is the shortest possible distance of a first straight line, which is tangent to the data lines H32, H34 of the second data line arrangement H1, H2, from a second straight line, which runs parallel to the first straight line through a cross-sectional centre point or through a stranding axis of the first data line arrangement 3 with the stranded data lines 332, 334, and if Y is a diameter of one of the stranded data lines 332, 334 including its insulation 322, 324, then X is 0.9 times the value of Y.

An advantage here is that the electromagnetic fields produced by the data lines H32, H34 of the second data line arrangement H1, H2, which fields occur principally in a data line intermediate space bordered between the data lines H32 and H34, only impair a data transmission via the data lines 332, 334 of the first line arrangement 3 to a reduced extent.

It is understood that the exemplary embodiments explained above are not conclusive and do not restrict the subject matter disclosed here. In particular, it is evident to the expert that he can combine the features described in any way with one another and/or can omit various features without deviating in this case from the subject matter disclosed here.

1. Combination cable for electrical energy and data transmission, having
one or more high-current lines;
a first data line pair, which has two data lines stranded with one another, which are at least partly enclosed by an electrically conductive sheath;
characterised in that
the electrically conductive sheath is adapted to take up a portion of energy emitted by the lines of the combination cable by means of electromagnetic waves and to convert these at least partly into heat;
two further data lines spaced at a distance from one another; wherein
the two further data lines that are spaced at a distance from one another are each arranged on an outer jacket surface of the at least partly electrically conductive sheath of the first data line pair, and
the two further data lines that are spaced at a distance from one another are spaced from one another by a distance of 1% to 31% of the jacket circumference of the sheath.

2. Combination cable according to claim 1, wherein
the one or more high-current lines is/are electrically insulated.

3. Combination cable according to claim 1, wherein
the one or more high-current lines is/are enclosed at least partly by an electromagnetic shield, in particular by a foil shield and/or braided shield.

4. Combination cable according to claim 1, wherein
the first data line pair has electrical insulation for each of the stranded data lines.

5. Combination cable according to claim 1, wherein the two further data lines are each electrically insulated.

6. Combination cable according to claim 1, wherein
the first data line pair is adapted to transmit data signals with a frequency of over one kilohertz; and/or
the two further data lines are adapted to transmit data signals with a frequency of below one kilohertz.

7. Combination cable according to claim 1, wherein
the electrically conductive sheath has an elliptical, in particular a circular, cross-sectional geometry.

8. Combination cable according to claim 1, wherein
the electrically conductive sheath completely encloses the first data line pair in a radial direction.

9. Combination cable according to claim 1, wherein
the electrically conductive sheath enclosing the first data line pair has a dielectric coating or lacquering, which forms the outer circumferential surface of the sheath.

10. Combination cable according to claim 1, having at least two high-current lines, wherein
the at least two high-current lines together border a high-current line intermediate space, and wherein
the data lines of the first data line pair and the two further data lines spaced at a distance from one another are each spaced at least by a predetermined distance from the high-current line intermediate space, and
the data lines of the first and the second data line pair are each spaced from a straight line, which is tangent to the two high-current lines, in a direction leading away from the high-current lines.

11. Combination cable according to claim 10, wherein
the at least two high-current lines are arranged unstranded adjacent to one another.

12. Combination cable according to claim 1, wherein,
if X is the shortest possible distance of a first straight line, which is tangent to both of the data lines spaced at a distance from one another, from a second straight line, which runs parallel to the first straight line through a cross-sectional centre point of the first data line pair, and
if Y is a diameter of a data line of the first data line pair, in particular the diameter of a data line of the first data line pair including insulation of this data line, then X is 0.9 times the value of Y.
